(19) United States
(12) Patent Application Publication
(10) Pub. No.: US 2018/0244108 A1
(43) Pub. Date: Aug. 30, 2018

(54) Pneumatic Radial Tire

(71) Applicant: The Yokohama Rubber Co., LTD., Minato-ku, Tokyo (JP)

(72) Inventor: Miyuki Nakajima, Hiratsuka-sbi, Kanagawa (JP)

(21) Appl. No.: 15/553,958

(22) PCT Filed: Feb. 18, 2016
(86) PCT No.: PCT/JP2016/054667

§ 371 Date: Aug. 25, 2017

(30) Foreign Application Priority Data
Feb. 26, 2015 (JP) 2015-036626

(51) Int. Cl. B60C 9/00; B60C 1/00; B60C 11/00; D02G 3/48; D02G 3/28; D02G 3/04; C08L 9/06

(52) U.S. Cl. CPC B60C 9/005; B60C 1/0016; B60C 9/0042; B60C 11/0008; D10B 2505/022; D02G 3/28; D02G 3/047; C08L 9/06; B60C 2011/0025; D02G 3/48

(57) ABSTRACT

A pneumatic radial tire of the present technology has a belt reinforcing layer and a tread rubber. The belt reinforcing layer comprises a composite fiber cord having one aromatic polyamide fiber cord and one aliphatic polyamide fiber cord twisted therein. A total fineness of the composite fiber cords is from 1800 to 3200 dtex and an elongation under a load of 2.0 cN/dtex is from 3.0 to 4.0%. A rubber composition constituting the tread rubber is formed by compounding from 10 to 110 parts by weight of a silica having a nitrogen adsorption specific surface area of not less than 100 m²/g with 100 parts by weight of a diene rubber. A loss compliance of the rubber composition at 60° C. is not greater than 45 Pa⁻¹.

### TECHNICAL FIELD

The present technology relates to a pneumatic radial tire, and more particularly relates to a pneumatic radial tire which achieves a reduction in weight while enhancing high-speed durability to or beyond conventional levels.

### BACKGROUND ART

Conventionally, in order to enhance the high-speed durability of a pneumatic radial tire or to reduce road noise, a belt reinforcing layer in which organic fiber cords are wrapped around the outer peripheral side of a belt layer in the tire circumferential direction is provided so as to impart a fastening effect to the belt layer. As organic fiber cords, it has been proposed to use a triple-twisted composite fiber cord or the like consisting of aramid fiber cords and nylon fiber cords (for example, see Japanese Unexamined Patent Application Publication No. 2011-68275A).

In recent years, there has been a demand to reduce tire weight in order to increase the fuel efficiency of pneumatic radial tires. When the triple-twisted composite fiber cord constituting a belt reinforcing layer is changed to a double-twisted composite fiber cord in order to reduce the weight of a tire, an effect of reducing flat spots and reducing road noise in the medium frequency region can be anticipated. However, when the belt reinforcing layer is formed from a double-twisted composite fiber cord, there are problems in that the fastening effect with respect to the belt layer becomes weak and the high-speed durability is diminished. Therefore, it has been difficult to achieve both reduction in tire weight and high-speed durability with the belt reinforcing layer consisting of a double-twisted composite fiber cord.

### SUMMARY

The present technology provides a pneumatic radial tire which achieves a reduction in weight while enhancing high-speed durability to or beyond conventional levels.

The pneumatic radial tire of the present technology is a pneumatic radial tire which comprises a carcass layer mounted between a pair of beads, a belt layer on an outer peripheral side of the carcass layer in a tread portion, and a belt reinforcing layer and a tread rubber on the outer peripheral side of the belt layer; the belt reinforcing layer comprising a composite fiber cord having one aromatic polyamide fiber cord and one aliphatic polyamide fiber cord twisted therein; the composite fiber cord having a total fineness of 1800 to 3200 dtex and an elongation under a load of 2.0 cN/dtex of 3.0 to 4.0%; and a rubber composition constituting the tread rubber being formed by compounding from 10 to 110 parts by weight of a silica having a nitrogen adsorption specific surface area of not less tan 100 m²/g with 100 parts by weight of a diene rubber, a loss compliance of the rubber composition at 60° C. is not greater than 45 Pa⁻¹.

In the pneumatic radial tire of the present technology, the belt reinforcing layer is formed from a double-twisted composite fiber cord including aromatic polyamide fiber and aliphatic polyamide fiber cords, and has the total fineness thereof is from 1800 to 3200 dtex, while the elongation under a load of 2.0 cN/dtex is from 3.0 to 4.0%. The rubber composition for the tread composition is formed by compounding from 10 to 110 parts by weight of a silica having a nitrogen adsorption specific surface area of not less than 100 m²/g with 100 parts by weight of a diene rubber, and the loss compliance at 60° C. is not greater than 45 Pa⁻¹. Therefore, it is possible to reduce the weight of the pneumatic radial tire while enhancing the high-speed durability to or beyond conventional levels.

The rubber composition constituting the tread rubber should contain from 50 to 90 wt. % of a terminal-modified solution polymerized styrene butadiene rubber having a styrene unit content of from 30 to 45 wt. % and a vinyl unit content of from 30 to 50 wt. % in 100 wt. % of the diene rubber, and the tensile stress at the time of 100% deformation of the rubber composition at 100° C. is preferably not less than 2.0 MPa.

### BRIEF DESCRIPTION OF DRAWINGS

FIG. 1 is a cross-sectional view in a tire meridian direction illustrating an example of a pneumatic radial tire according to an embodiment of the present technology.

### DETAILED DESCRIPTION

The configuration of the present technology will be described hereinafter with reference to the drawings.

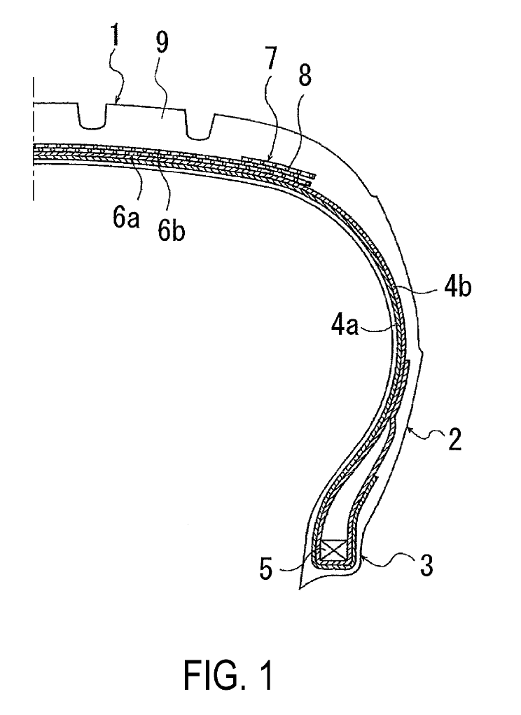

In FIG. 1, the pneumatic radial tire of the present technology comprises a tread portion 1, a sidewall portion 2, and a bead portion 3. Carcass layers 4a and 4b are provided between a pair of left and right beads 5, and at least two belt layers 6a and 6b, in which the cord directions intersect between the layers, are disposed on the outer peripheral side of the carcass layers 4a and 4b of the tread portion 1. A belt reinforcing layer 7 formed by winding a composite fiber cord 8 in a spiral shape at an angle of from 0 to 5° with respect to the tire circumferential direction is disposed on the outer peripheral side of the belt layers 6a and 6b. In addition, a tread rubber 9 is disposed on the outer peripheral side of the belt layers 6a and 6b and the belt reinforcing layer 7 of the tread portion 1. The tread rubber 9 is formed from a rubber composition for treads.

In the pneumatic radial tire of the present technology, the composite fiber cord 8 constituting the belt reinforcing layer 7 is formed from a double-twisted fiber cord having one aromatic polyamide fiber cord and one aliphatic polyamide fiber cord twisted therein. By forming the belt reinforcing layer 7 with a double-twisted composite fiber cord, it is possible to reduce the tire weight in comparison to when a triple-twisted composite fiber cord is used. Further, it is possible to reduce medium frequency road noise.

An aromatic polyamide fiber cord ordinarily used in pneumatic radial tires may be used as the aromatic polyamide fiber cord, and an example thereof is an aramid fiber cord.

An aliphatic polyamide fiber cord ordinarily used in pneumatic radial tires may be used as the aliphatic polyamide fiber cord, and examples thereof include a Nylon 66 fiber cord, a Nylon 6 fiber cord, a Nylon 6/66 fiber cord, a Nylon 610 fiber cord, a Nylon 612 fiber cord, a Nylon 46 fiber cord, and the like. Of these, a Nylon 66 fiber cord, a Nylon 46 fiber cord, or the like is preferable.

The total fineness of the composite fiber cord 8 constituting the belt reinforcing layer 7 is from 1800 to 3200 dtex and preferably from 2000 to 2500 dtex. When the total fineness of the composite fiber cord 8 is less than 1800 dtex, the cord strength is insufficient, and the high-speed durability is insufficient. In addition, when the total fineness of the composite fiber cord 8 exceeds 3200 dtex, the tire weight becomes large.

Further, the elongation when a load of 2.0 cN/dtex is applied to the composite fiber cord 8 is from 3.0 to 4.0% and preferably from 3.2 to 3.8%. When the elongation of the composite fiber cord 8 under a load of 2.0 cN/dtex is less than 3.0%, the fatigue resistance of the composite fiber cord is insufficient. When the elongation under a load of 2.0 cN/dtex exceeds 4.0%, the effect of reducing medium frequency road noise is not achieved. In the present specification, the elongation of the composite fiber cord under a load of 2.0 cN/dtex is measured in accordance with JIS L1017 by sampling a composite fiber cord from the pneumatic radial tire. In addition, the elongation of the composite fiber cord under a load of 2.0 cN/dtex can be adjusted by the total fineness, the number of twists, the tension in the fiber cord in the surface treatment step, or the like.

In the pneumatic radial tire of the present technology, the rubber composition constituting the tread rubber (hereinafter sometimes referred to as “rubber composition for treads”) is formed by compounding from 10 to 110 parts by weight of a silica having a nitrogen adsorption specific surface area of not less than 100 m²/g with 100 parts by weight of a diene rubber, and the loss compliance of this rubber composition at 60° C. needs to be not greater than 45 Pa⁻¹.

The rubber component of the rubber composition for treads include a diene rubber. Examples of the diene rubber include natural rubbers, isoprene rubbers, butadiene rubbers, styrene butadiene rubbers, acrylonitrile butadiene rubbers, butyl rubbers, chloroprene rubbers, and the like. These diene rubbers may be used alone or in a desirable blend thereof.

Examples of preferable diene rubbers in the rubber composition for treads include styrene butadiene rubbers, butadiene rubbers, natural rubbers, and the like. Of these, a solution polymerized styrene-butadiene rubber is preferable, and a terminal-modified solution-polymerized styrene butadiene rubber having a styrene unit content of from 30 to 45 wt. % and a vinyl unit content of from 30 to 50 wt. % is particularly preferable. Containing a terminal-modified solution-polymerized styrene butadiene rubber increases the affinity with the silica and enhances the dispersibility of the silica with respect to the diene rubber.

The styrene unit content of the terminal-modified solution-polymerized styrene butadiene rubber is preferably from 30 to 45 wt. % and more preferably from 35 to 45 wt. %. When the styrene unit content is less than 30 wt. %, the effects of increasing the rigidity and the strength of the rubber composition cannot be sufficiently achieved. When the styrene unit content exceeds 45 wt. %, the glass transition temperature (Tg) increases, and the balance of the viscoelastic characteristics becomes poor; thus, it is difficult to achieve the effect of reducing heat build-up. Note that the styrene unit content of the styrene-butadiene rubber is measured by infrared spectroscopy (Hampton method).

In addition, the vinyl unit content of the terminal-modified solution-polymerized styrene butadiene rubber is preferably from 30 to 50 wt. % and more preferably from 30 to 40 wt. %. When the vinyl unit content is less than 30 wt. %, the Tg of the styrene-butadiene rubber becomes low, and the dynamic viscoelasticity characteristic loss tangent (tan δ) at 0° C., which is an indicator of the wet performance, is diminished. When the vinyl unit content exceeds 50 wt. %, the glass transition temperature (Tg) increases, and the tan δ at 60° C., which is an indicator of low rolling performance, becomes large, thereby diminishing the low rolling performance. Note that the vinyl unit content of the styrene-butadiene rubber is measured by infrared spectroscopy (the Hampton method).

The content of the terminal-modified solution-polymerized styrene butadiene rubber is preferably from 50 to 90 wt. %, more preferably from 60 to 85 wt. %, and further preferably from 65 to 80 wt. % in 100 wt. % of the diene rubber. When the content of the terminal-modified solution-polymerized styrene butadiene rubber is less than 50 wt. % of the diene rubber, the affinity with the silica becomes insufficient.

Since the rubber composition for treads contains silica, the heat build-up is reduced, and high temperatures are suppressed when traveling. This makes it possible to increase the high-speed durability. The compounded amount of the silica is from 10 to 110 parts by weight, preferably from 50 to 100 parts by weight, and more preferably from 60 to 90 parts by weight in 100 parts by weight of the diene rubber. When the compounded amount of the silica is less than 10 parts by weight, the hardness of the rubber composition dramatically decreases, and the rubber of the tread portion becomes more mobile, so the effect of suppressing heat build-up cannot be sufficiently achieved. In addition, when the compounded amount of the silica exceeds 110 parts by weight, the compliance at 60° C. increases, and the high-speed durability conversely decreases.

The nitrogen adsorption specific surface area (N2SA) of the silica used in the present technology is not less than 100 m²/g, preferably from 100 to 250 m²/g, and more preferably from 150 to 250 m²/g. By setting the N2SA to not less than 100 m²/g, it is possible to increase the hardness of the rubber composition and suppress the movement of the rubber of the tread portion. The N2SA of the silica is measured in accordance with JIS (Japanese Industrial Standard) K6217-2.

The silica may be any silica that is regularly used in pneumatic radial tires. Examples thereof include wet method silica, dry method silica, surface treated silica, and the like.

In the rubber composition for treads, blending a silane coupling agent together with the silica enhances the dispersibility of the silica, increases the crosslinking density, and increases the hardness, which makes it possible to further reduce heat build-up. The compounded amount of the silane coupling agent is preferably from 5 to 15 wt. % and more preferably from 5 to 10 wt. %, of the compounded amount of the silica. When the compounded amount of the silane coupling agent is less than 5 wt. % of the weight of the silica, the effect of improving the dispersibility of the silica cannot be sufficiently obtained. Furthermore, when the compounded amount of the silane coupling agent exceeds 15 wt. %, the silane coupling agents polymerize with each other, and the desired effects cannot be obtained. Further, buildup on the roll becomes large at the time of the preparation of the rubber composition.

The silane coupling agent is not particularly limited, but is preferably a sulfur-containing silane coupling agent. Examples thereof include bis-(3-triethoxysilylpropyl)tetrasulfide, bis(3-triethoxysilylpropyl)disulfide, 3-trimethoxysilylpropyl benzothiazole tetrasulfide, γ-mercaptopropyltriethoxysilane, 3-octanoylthiopropyl triethoxysilane, and the like.

In the present technology, the loss compliance of the rubber composition for treads at 60° C. needs to be not greater than 45 Pa⁻¹. By setting the loss compliance at 60° C. to not greater than 45 Pa⁻¹, it is possible to reduce heat build-up and to enhance high-speed durability. The loss compliance at 60° C. is preferably from 20 to 45 Pa⁻¹ and more preferably from 25 to 40 Pa⁻¹. The loss compliance of the rubber composition for treads can be adjusted by the compounded amount of the silica or the like. In the present specification, the loss compliance L is determined by the following general formula (1).

LC=E″/(E*)² (1)

In formula (1), LC is the loss compliance [units: Pa⁻¹], E″ is the loss modulus [MPa], and E* is the complex modulus of elasticity [MPa].

In the present specification, the complex modulus of elasticity E* and the loss modulus E″ of the rubber composition for treads are measured in accordance with the provisions set forth in JIS K6394 using a viscoelastic spectrometer (manufactured by Toyo Seiki Seisaku-sho, Ltd.) under conditions of an initial strain of 10%, an amplitude of ±2%, a frequency of 20 Hz, and a temperature of 60° C.

The tensile stress of the rubber composition for treads at the time of 100% deformation at 100° C. is preferably not less than 2.0 MPa and more preferably from 2.0 to 3.0 MPa. By setting the tensile stress at the time of 100% deformation at 100° C. to not less than 2.0 MPa, it is possible to suppress the repetitive deformation of the rubber composition for treads and to reduce heat build-up. This makes it possible to further increase the high-speed durability of the pneumatic radial tire. In the present specification, the tensile stress at the time of 100% deformation at 100° C. is measured in accordance with JIS K6251 by performing a tensile test at 100° C. using a No. 3 dumbbell-shaped test piece and measuring the tensile stress at the time of 100% deformation.

In the present technology, other compounding agents in addition to those described above may be added to the rubber composition for treads. Examples of other compounding agents include various compounding agents that are commonly used in pneumatic tires such as reinforcing fillers other than silica, vulcanization or crosslinking agents, vulcanization accelerators, antiaging agents, liquid polymers, thermosetting resins, and thermoplastic resins. These compounding agents can be compounded in typical amounts conventionally used so long as the objects of the present technology are not hindered. In addition, an ordinary rubber kneading machine such as a Banbury mixer, a kneader, or a roll may be used as a kneader.

Examples of other reinforcing fillers include carbon black, clay, mica, talc, calcium carbonate, aluminum hydroxide, aluminum oxide, titanium oxide, and the like. Of these, carbon black is preferable.

The present technology will be described further hereinafter using examples. However, the scope of the present technology is not limited to these examples.

### EXAMPLES

Rubber compositions for treads (Examples 1 to 3 and Comparative Examples 1 to 4) were prepared according to the formulations shown in Table 1 with the compounding agents shown in Table 2 used as common components. With the exception of the sulfur and the vulcanization accelerators, the components were kneaded in a 1.7 L sealed Banbury mixer, and after a prescribed amount of time passed, the mixture was discharged from the mixer and cooled at room temperature. This was placed in the 1.7 L sealed Banbury mixer, and the sulfur and the vulcanization accelerators were then added to the master batch and mixed to produce a rubber composition for treads. Note that in the rows of “Diene rubber (SBR1, SBR2)” in Table 1, the net compounded amount, except the amount of the oil-extending component, of SBR (styrene butadiene rubber) is written in parentheses in addition to the compounded amount of the product. Furthermore, the compounded amounts of the compounding agents shown in Table 2 are expressed as parts by weight per 100 parts by weight of the diene rubbers shown in Table 1.

The obtained rubber composition for treads was press vulcanized for 20 minutes at 160° C. in a prescribed mold (150 mm×150 mm×2 mm) to fabricate a vulcanized test piece. The loss compliance and tensile stress (100%, 100° C.) were measured in accordance with the following methods.

### Loss Compliance (60° C.)

The vulcanized test piece of the obtained rubber composition for treads was used to measure the complex modulus of elasticity E* and the loss modulus E″ in accordance with JIS K6394:2007 using a viscoelastic spectrometer (manufactured by Toyo Seiki Seisaku-sho, Ltd.) under conditions at an initial strain of 10%, an amplitude of ±2%, a frequency of 20 Hz, and a temperature of 60° C., and the loss compliance at 60° C. was calculated by formula (1) above. The obtained results are shown in the “Loss compliance” row of Table 1.

### Tensile Stress (100%, 100° C.)

A JIS No. 3 dumbbell shaped test piece was cut out from the obtained vulcanized test pieces in accordance with JIS K6251. The tensile stress at the time of 100% deformation was measured in accordance with JIS K6251 under conditions at a tensile test speed of 500 mm/min and an ambient temperature of 100° C. The obtained results are shown in the “tensile stress (100%, 100° C.)” row of Table 1.

Using the rubber composition for treads obtained above as a tread rubber, seven types of pneumatic radial tires (tire size: 215/55R17) having a belt reinforcing layer formed from the rubber composition for treads shown in Table 1 and a composite fiber cord were vulcanization-molded. Note that the structures of the composite fiber cords shown in Table 1 indicates the fineness of the aramid fiber cord and the Nylon 66 fiber cord, and the composite fiber cord of Comparative Example 1 refers to a triple-twist structure comprising 2 aramid fiber cords (1,670 dtex) and one Nylon 66 fiber cord (1,400 dtex). In addition, in the structures of the composite fiber cords of Comparative Examples 2 to 4 and Examples 1 to 3, the first number indicates the fineness (dtex) of the aramid fiber cord, and the second number indicates the fineness (dtex) of the Nylon 66 fiber cord, thus referring to a double-twisted structure.

The high-speed durability was measured with the method described below for the obtained seven types of pneumatic radial tires. In addition, belt reinforcing layers were sampled from the seven types of pneumatic radial tires, and the weight of each belt reinforcing layer and the elongation of the composite fiber cord when a load of 2.0 cN/dtex was applied were measured in accordance with the following evaluation methods.

Elongation Under a Load of 2.0 cN/dtex

Ten composite fiber cords were sampled from the belt reinforcing layers sampled from the pneumatic radial tires, and the elongation when a load of 2.0 cN/dtex was applied was measured in accordance with JIS L1017. The obtained results are shown in the “Elongation under a load of 2.0 cN/dtex” row of Table 1.

### Weight of the Belt Reinforcing Layer

The weight per unit length of the belt reinforcing layer sampled from the pneumatic radial tire was measured. The obtained results were recorded in Table 1 as index values with the value for Comparative Example 1 being defined as 100 and are shown in the “Weight of the belt reinforcing layer” row of Table 1. A smaller index value means that the belt reinforcing layer is lighter and that the weight of the tire can be reduced.

### High-Speed Durability

The obtained pneumatic radial tire was mounted on a standard rim (size: 17×7 JJ) and filled to an air pressure of 230 MPa. This tire was placed in an indoor drum testing machine (drum diameter: 1707 mm), and a high-speed durability test prescribed by JATMA (Japan Automobile Tyre Manufacturers Association, Inc.) was performed. After this high-speed durability test was complete, the test speed was increased in increments of 50 km/hr. Tests were continued until the tire was destroyed, and the travel distance was measured. The obtained results were recorded in Table 1 as index values with the value for Comparative Example 1 being defined as 100 and are shown in the “High-speed durability” row of Table 1. Larger indices indicate superior high-speed durability.

TABLE 1

| | | | Comparative | Comparative | Comparative |
|---|---|---|---|---|---|
| | | | Example 1 | Example 2 | Example 3 |
| Tread | SBR 1 | parts by | 96.3 | 96.3 | 96.3 |
| rubber | | weight | (70) | (70) | (70) |
| | SBR 2 | parts by | | | |
| | | weight | | | |
| | BR | parts by | 30 | 30 | 30 |
| | | weight | | | |
| | Silica | parts by | 70 | 70 | 70 |
| | | weight | | | |
| | Coupling agent | parts by | 7 | 7 | 7 |
| | | weight | | | |
| Cord | Number of fiber cords | cords | 3 | 2 | 2 |
| Composite | Cord structure | dtex | 1670 + 1670 + 1400/3 | 800 + 940/2 | 1670 + 1400/2 |
| fiber | Total fineness | dtex | 4740 | 1740 | 3070 |

| | | | | |
|---|---|---|---|---|
| Loss compliance (60° C.) | Pa⁻¹ | 36 | 36 | 36 |
| Tensile stress (100%, 100° C.) | MPa | 2.0 | 2.0 | 2.0 |
| Elongation under a load of 2.0 | % | 2.2 | 4.5 | 4.5 |
| cN/dtex | | | | |
| Weight of the belt reinforcing layer | Index | 100 | 85 | 88 |
| | value | | | |
| High-speed durability | Index | 100 | 90 | 97 |
| | value | | | |

| | | | Comparative | | | |
|---|---|---|---|---|---|---|
| | | | Example 4 | Example 1 | Example 2 | Example 3 |
| Tread | SBR 1 | parts by | 96.3 | 96.3 | 96.3 | |
| rubber | | weight | (70) | (70) | (70) | |
| | SBR 2 | parts by | | | | 96.3 |
| | | weight | | | | (70) |
| | BR | parts by | 30 | 30 | 30 | 30 |
| | | weight | | | | |
| | Silica | parts by | 120 | 70 | 70 | 70 |
| | | weight | | | | |
| | Coupling agent | parts by | 12 | 7 | 7 | 7 |
| | | weight | | | | |
| Cord | Number of fiber cords | cords | 2 | 2 | 2 | 2 |
| Composite | Cord structure | dtex | 1670 + 1400/2 | 1670 + 1400/2 | 1100 + 940/2 | 1100 + 940/2 |
| fiber | Total fineness | dtex | 3070 | 3070 | 2040 | 2040 |

| | | | | | |
|---|---|---|---|---|---|
| Loss compliance (60° C.) | Pa⁻¹ | 47 | 36 | 36 | 28 |
| Tensile stress (100%, 100° C.) | MPa | 2.0 | 2.0 | 2.0 | 2.5 |
| Elongation under a load of 2.0 | % | 3.5 | 3.5 | 3.5 | 3.5 |
| cN/dtex | | | | | |
| Weight of the belt reinforcing layer | Index | 83 | 83 | 76 | 76 |
| | value | | | | |
| High-speed durability | Index | 92 | 105 | 104 | 110 |
| | value | | | | |

The types of raw materials used in Table 1 are described below.
SBR1: Terminal-modified solution-polymerized styrene butadiene rubber, SBR NS460 manufactured by the Zeon Corporation; oil extended product prepared by compounding 37.5 parts by weight of an oil component with 100 parts by weight of a styrene-butadiene rubber; styrene content: 25 wt. %; vinyl unit content: 63 wt. %; weight average molecular weight: 780000
SBR2: Terminal-modified solution-polymerized styrene butadiene rubber, SBR E581 manufactured by the Asahi Kasei Corporation; oil extended product prepared by compounding 37.5 parts by weight of an oil component with 100 parts by weight of a styrene-butadiene rubber; styrene content: 40 wt. %; vinyl unit content: 44 wt. %; weight average molecular weight: 1.26 million
BR: Butadiene rubber; Nipol BR1220, manufactured by Zeon Corporation
Silica: Zeosil 115GR, manufactured by Rhodia; nitrogen adsorption specific surface area: 160 m²/g
Coupling agent: Sulfur-containing silane coupling agent; bis(3-triethoxysilylpropyl) tetrasulfide, Si 69, manufactured by Evonik

TABLE 2
Shared Formulation of the Rubber Compositions

| | |
|---|---|
| Carbon black | 10.0 parts by weight |
| Stearic acid | 2.0 parts by weight |
| Zinc oxide | 3.0 parts by weight |
| Antiaging agent | 3.0 parts by weight |
| Aroma oil | 10.0 parts by weight |
| Sulfur | 2.0 parts by weight |
| Vulcanization accelerator 1 | 2.0 parts by weight |
| Vulcanization accelerator 2 | 1.0 parts by weight |

The types of raw materials used in Table 2 are shown below.
Carbon black: SEAST 6, manufactured by Tokai Carbon Co., Ltd.
Stearic acid: Beads stearic acid, manufactured by NOF Corporation
Zinc oxide: Zinc Oxide III, manufactured by Seido Chemical Industry Co., Ltd.
Anti-aging agent: Santoflex 6PPD, manufactured by Flexsys
Aroma oil: Extract No. 4S, manufactured by Showa Shell Sekiyu K.K.
Sulfur: “Golden Flower” oil-treated sulfur powder, manufactured by Tsurumi Chemical Industry, Co., Ltd.
Vulcanization accelerator 1: CBS, NOCCELER CZ-G manufactured by Ouchi Shinko Chemical Industrial Co., Ltd.
Vulcanization accelerator 2: DPG; Soxinol D-G manufactured by Sumitomo Chemical Industrial Co., Ltd.

As is clear from Table 1, it was confirmed that the pneumatic radial tires manufactured in Examples 1 to 3 exhibit a reduction in weight in the belt reinforcing layer and have excellent high-speed durability.

In the pneumatic radial tire of Comparative Example 2, the total fineness of the double-twisted composite fiber cord is less than 1800 dtex, and the elongation under a load of 2.0 cN/dtex exceeds 4.0%, so the high-speed durability is poor.

In the pneumatic radial tire of Comparative Example 3, the elongation of the double-twisted composite fiber cord under a load of 2.0 cN/dtex exceeds 4.0%, so the high-speed durability is poor.

In the pneumatic radial tire of Comparative Example 4, the loss compliance of the tread rubber exceeds 45 Pa⁻¹, so the high-speed durability is poor.

1. A pneumatic radial tire comprising a carcass layer mounted between a pair of beads, a belt layer on an outer peripheral side of the carcass layer in a tread portion, and a belt reinforcing layer and a tread rubber on an outer peripheral side of the belt layer;
the belt reinforcing layer comprising a composite fiber cord having one aromatic polyamide fiber cord and one aliphatic polyamide fiber cord twisted therein;
a total fineness of the composite fiber cords being from 1800 to 3200 dtex;
an elongation under a load of 2.0 cN/dtex being from 3.0 to 4.0%;
a rubber composition constituting the tread rubber being formed by compounding from 10 to 110 parts by weight of a silica having a nitrogen adsorption specific surface area of not less than 100 m²/g with 100 parts by weight of a diene rubber; and
a loss compliance of the rubber composition at 60° C. being not more than 45 Pa′.

2. The pneumatic radial tire according to claim 1, wherein the rubber composition constituting the tread rubber contains from 50 to 90 wt. % of a terminal-modified solution polymerized styrene butadiene rubber having a styrene unit content of from 30 to 45 wt. % and a vinyl unit content of from 30 to 50 wt. % in 100 wt. % of the diene rubber, and a tensile stress at 100% deformation of the rubber composition at 100° C. is not less than 2.0 MPa.
